(19) United States
(12) Patent Application Publication
(10) Pub. No.: US 2010/0084285 A1
(43) Pub. Date: Apr. 8, 2010

(54) PROCESS ANALYTIC SENSOR WITH MOISTURE-SCAVENGING ELECTRODE BACKFILL

(76) Inventors: Barry W. Benton, Orange, CA (US); Chang-Dong Feng, Long Beach, CA (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/246,627

(22) Filed: Oct. 7, 2008

(51) Int. Cl. G01N 27/26; G01N 27/30; G01N 27/36; F16J 15/14

(52) U.S. Cl. 205/775; 204/400; 204/435; 204/433; 277/316

(57) ABSTRACT

A process analytic sensor for sensing a characteristic of a process fluid is disclosed. The sensor includes a housing including a sensing portion having an electrical characteristic that varies with a characteristic of the process fluid. An instrument cable has at least one electrical conductor. An electrode connection space is located within the housing and the at least one electrical conductor is electrically coupled to a respective conductor of a sensing element of the sensing portion. A fill material is disposed in the electrode connection space. The fill material cures through exposure to moisture and the fill material is uncured and sealed within the electrode connection space.

### BACKGROUND

Process analytic sensors are generally configured to couple to a given process, such as an oil refining process or a pharmaceutical manufacturing process, and provide an analytical output relative to the process. Examples of such analytical outputs include, but are not limited to: measurement of pH; measurement of oxidation reduction potential; selective ion measurement; and measurement of dissolved gases, such as dissolved oxygen. These analytical measurements can then be provided to a control system such that process control can be effected and/or adjusted based upon the analytic measurement. Such sensors are generally continuously, or substantially continuously, exposed to the process medium.

Process analysis is very demanding. On the one hand, industry requires higher and higher accuracy and precision with respect to process analytical measurements. On the other hand, the processes to which such sensors are exposed are becoming more demanding in terms of pressure and temperature. A failure mode that is becoming increasingly common to process analytic sensors, as both the temperature and pressure of industrial requirements rise, is the loss of signal integrity due to decreased signal isolation. Once signal integrity is lost, it is necessary to replace or repair the process analytic sensor, which can potentially require that the entire process be taken offline. Accordingly, providing process analytic sensors that are more robust and better able to withstand exposure to the process and/or ambient environment, will benefit the process analytic industries.

### SUMMARY

A process analytic sensor for sensing a characteristic of a process fluid is disclosed. The sensor includes a housing including a sensing portion having an electrical characteristic that varies with a characteristic of the process fluid. An instrument cable has at least one electrical conductor. An electrode connection space is located within the housing and the at least one electrical conductor is electrically coupled to a respective conductor of a sensing element of the sensing portion. A fill material is disposed in the electrode connection space. The fill material cures through exposure to moisture and the fill material is uncured and sealed within the electrode connection space.

### BRIEF DESCRIPTION OF THE DRAWINGS

FIG. 1 is a diagrammatic view of a process analytic system with which embodiments of the present invention are useful.

FIG. 2 is a cross-sectional diagrammatic view of a process analytic sensor in accordance with an embodiment of the present invention.

FIG. 3 is a flow diagram of a method of constructing a process analytic sensor in accordance with an embodiment of the present invention.

### DETAILED DESCRIPTION OF ILLUSTRATIVE EMBODIMENTS

Modern process analytic sensors are being increasingly fabricated of polymeric materials. These materials are slightly permeable to moisture. Seals are typically press-fit or created using elastomeric compression rings (such as rubber O-rings) which also have miniscule but measurable moisture leak rates. It is typical for this moisture to pass through the process analytic sensor electrode connection space from the measured process to the ambient environment. Worse, it is even possible for moisture to accumulate within the electrode connection space. This moisture forms an electrolyte film of metallic corrosion by-products and unreacted components (from typical epoxy backfills) that degrade the measurement signal by creating a path to ground and/or introducing spurious galvanic currents.

Embodiments of the present invention generally provide a moisture-curing RTV silicone in an electrode connection space of a process analytic sensor. This sealed design then prevents the full-cure of the RTV silicone so that the RTV silicone itself, which provides the function of electrically isolating electrodes within the electrode space as well as filling the space to enhance mechanical integrity, provides the additional feature of scavenging moisture through the operational life of the process analytic sensor. A typical example of an embodiment of the invention is the construction of a pH sensor, where undesired moisture permeation through the plastic or rubber sensor components can be consumed, or otherwise sequestered by the RTV silicone backfill thereby preventing the deterioration of the electric insulation between the lead wires, which is critical to pH sensor performance. Sealing uncured RTV (Room Temperature Vulcanization) silicone into the connection space as a backfill prevents the cure of silicone by inhibiting contact from atmospheric moisture to the silicone. Thus isolated, the silicone will remain uncured in the process analytic sensor for months, to years, just as it would have in the original unopened container. However, just as the uncured silicone will eventually cure and harden in the container from moisture leakage through the walls and cap seal of the container, it will do so in the process analytic sensor, by scavenging damaging moisture leaking into connection space.

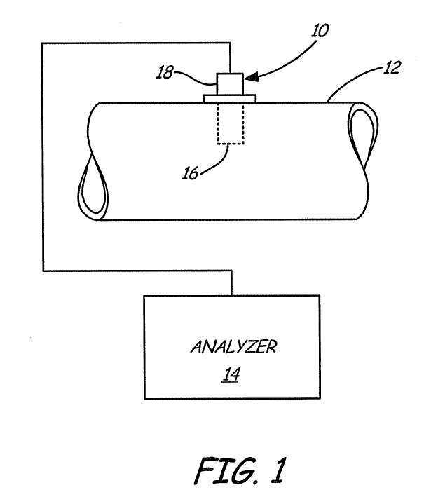

FIG. 1 is a diagrammatic view of a process analytic sensor 10 coupled to a process, illustrated diagrammatically as pipe 12 and a process analyzer 14. Process analytic sensor 10 is an insertion-type process analytic sensor having a distal end 16 and a proximal end 18. Distal end 16 is adapted for contact with process media within pipe 12 and provides an analytical indication relative to the process medium.

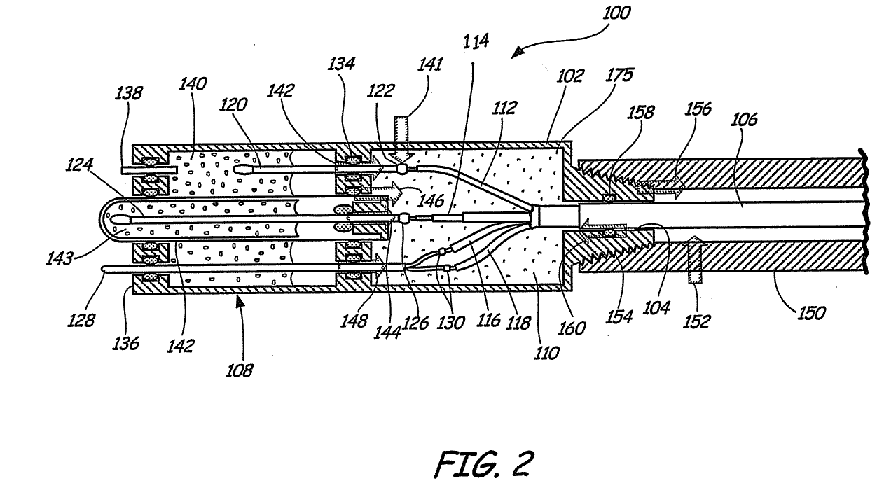

FIG. 2 is a cross sectional diagrammatic view of a process analytic sensor in accordance with an embodiment of the present invention. Sensor 100 includes sensor housing 102 that includes an aperture 104 sized to receive instrument cable 106. In the embodiment illustrated in FIG. 2, process analytic sensor 100 is a pH sensor, but embodiments of the present invention can be practiced for any suitable type of process analytic sensor including conductivity sensors, oxygen sensors, chlorine sensors, et cetera. Housing 102 includes sensing region 108 and electrode connection space 110. Within electrode connection space 110, individual electrical conductors 112, 114, 116 and 118 are coupled to respective conductors of sensors within sensor housing 102. Conductor 112 is coupled to reference electrode 120 at connection 122; conductor 114 is coupled to glass pH electrode 124 at connection 126 while conductors 116 and 118 are coupled to temperature sensor 128 at connections 130. Sensing region 108 is separated from electrode connection space 110 via feed through 134 that essentially comprises a wall separating region 108 from space 110 with suitable apertures placed therein to allow the respective sensors and electrodes to pass therethrough. Further, the dotted ovals surrounding each of the electrodes and sensors represent elastomeric O-rings configured to seal sensing region 108 from electrode connection space 110. Additionally, distal end 136 of sensor 100 includes a number of apertures that provide access to the test sample. Specifically, an aperture exists to accommodate reference junction 138 between the region external to sensor 100, and the internal volume of sensing region 108 which is filled with a concentrated electrolytic solution 140, such as a potassium chloride solution. Reference junction 138 is sealed by an O-ring, which is preferably elastomeric. pH glass electrode 124 includes a glass wall 142 containing therein a concentrated potassium chloride salt solution 143. Electrode 124 also passes through an aperture in distal end 136, which aperture is sealed by an O-ring, or other suitable seal that is preferably elastomeric. Finally, temperature sensor 128 is configured to be directly exposed to the test sample through an aperture which is also sealed with an O-ring.

Electrode connection space 110, also referred to herein as backfill volume 110, is sealed from both sensor region 108, and the exterior of sensor 100. Over the months or years through which process analytic sensor 100 operates, it is possible for moisture to slowly creep into space 110 through a number of vectors. First, moisture can slowly creep directly through the side wall of housing 102, as illustrated at arrow 141. Similarly, moisture can creep through sensor housing feed through 134 proximate sensing region 108, and slowly make its way through the various elastomeric O-rings, as illustrated at arrows 142, 144, 146, 148. Further, it is possible for moisture to move directly through the side wall of submersion pipe 150 as illustrated by arrow 152. Additionally, moisture can pass through threaded interface 154 as illustrated by arrow 156. The moisture passing through vectors 152 and/or 156 can then make its way through O-ring 158 as illustrated by arrow 160. The net effect of these various, albeit slow, leaks is that moisture can accumulate in the electrode connection space 110. In accordance with an embodiment of the present invention, backfill volume 110 is filled with an insulating material that occupies the otherwise empty space, but also that scavenges moisture. In a preferred embodiment, this material is an RTV silicone 175 that substantially fills backfill volume 110. Further still, it is preferred that the backfill be a single, homogeneous mass of substantially uncured, one-part moisture-cure silicone RTV.

When sensor 100 is manufactured, an uncured RTV silicone is preferably inserted within backfill volume 110 and the silicone 175 is not allowed to cure. Instead, a seal is generated by completing assembly of sensor 100. In this way, RTV silicone 175 within space 110 is denied the moisture it needs to fully cure. However, over the lifetime of sensor 100, as moisture passes any of the various vectors identified above, the moisture will be scavenged or otherwise sequestered by the RTV silicone which will chemically bind the moisture and use it to further partially cure. Suitable example of the RTV silicone useful with embodiments of the present invention and its curing mechanism on exposure to water molecules are shown in the following reactions

≡Si—OH+RSiX₃→≡Si—O—Si(X₂R)+HX

Polyorganosiloxane crosslinker

3≡Si—O—SiX₂R+H₂O→(≡Si—O—)₃SiR+HX

As shown in the reactions, the curing process involves two condensation reactions, the first condensation occurs when the hydroxyl group reacts with the X group forming a Si—O—Si link and HX; the second condensation occurs when the X groups of the partially crosslinked chains react with water forming more Si—O—Si links and HX. The type of X group in the crosslinker is summarized in the following table.

| Type of crosslinker | X group Name | X group formula |
|---|---|---|
| Acidic | Acetoxy | 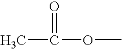 |
| | Octoate | 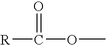 |
| Neutral | Amide | 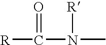 |
| | Oxime | 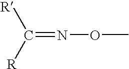 |
| | Alkoxy | R—O— |
| Alkaline | Amine | 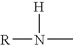 |

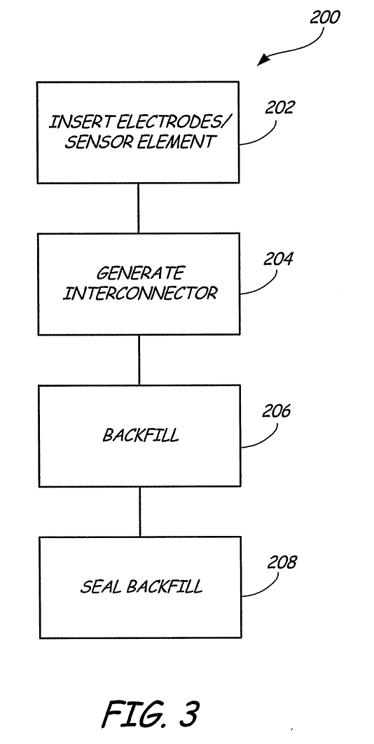

FIG. 3 is a flow diagram of a method of constructing a process analytic sensor in accordance with an embodiment of the present invention. Method 200 begins at block 202 where the various electrodes and sensor elements, such as electrode 120, electrolyte solution 140 and temperature sensor 128 are inserted into a sensor housing, such as sensor housing 102. Next, at step 204, the various electrical interconnects between the sensor elements and electrodes are generated with an instrument cable, such as instrument cable 106. Next, at block 206, an electrode connection space is filled with an RTV silicone backfill. Then, before the RTV silicone can cure fully (and preferably to any appreciable extent), the electrode connection space is sealed to thereby prevent moisture or air from contacting the RTV silicone within the electrode connection space, as illustrated at block 208. The assembled sensor can then be exposed to a process fluid for analyzing a characteristic of the process fluid, such as pH. As moisture slowly creeps into the electrode connection space, the uncured RTV backfill will scavenge the moisture and prevent it from generating undesirable corrosion and/or cross currents or potentials. Moreover, since curing of the RTV silicone increases the hardness of the silicone, it is possible for technicians to gauge the relative amount of cure (and accordingly remaining available lifetime of the sensor) by squeezing sensor housing 102 in the area proximate connection space 110 and determine whether the housing flexes readily, or not.

Although the present invention has been described with reference to preferred embodiments, workers skilled in the art will recognize that changes may be made in form and detail without departing from the spirit and scope of the invention. For example, while embodiments of the present invention have been described with respect to a process analytic pH sensor, embodiments of the present invention can be practiced with any suitable process analytic sensors.

What is claimed is:

1. A process analytic sensor for sensing a characteristic of a process fluid, the sensor comprising:
a housing including a sensing portion having an electrical characteristic that varies with a characteristic of the process fluid;
an instrument cable having at least one electrical conductor;
an electrode connection space within the housing, wherein the at least one electrical conductor is electrically coupled to a respective conductor of a sensing element of the sensing portion; and
a single, homogeneous mass of fill material disposed in the electrode connection space, wherein the fill material is substantially uncured, and is a one-part moisture-cure fill material.

2. The process analytic sensor of claim 1, wherein the fill material is an RTV silicone rubber.

3. The process analytic sensor of claim 1, wherein the sensing element comprises a temperature sensor.

4. The process analytic sensor of claim 1, wherein the sensing element includes at least one electrode within the sensing portion.

5. The process analytic sensor of claim 4, wherein the at least one electrode includes a reference electrode.

6. The process analytic sensor of claim 4, wherein the at least one electrode includes a pH glass electrode.

7. The process analytic sensor of claim 6, wherein the pH glass electrode is filled with an electrolyte.

8. The process analytic sensor of claim 1, wherein the sensor is a pH sensor.

9. The process analytic sensor of claim 1, wherein the housing is constructed from a polymeric material.

10. The process analytic sensor of claim 1, wherein the housing includes an externally threaded region configured to engage a pipe mount.

11. The process analytic sensor of claim 1, wherein the instrument cable includes a plurality of conductors, each being coupled through a connection within the electrode connection space.

12. A method of constructing a process analytic sensor, the method comprising:
providing a sensor housing;
placing at least one sensing element within the sensor housing;
providing an instrument cable;
connecting at least one conductor of the instrument cable to a respective sensing element, wherein the connection is located within a connection space of the sensor housing;
filling the connection space with a moisture-curing backfill material; and
sealing the connection space before substantially any of the backfill material fully cures.

13. The method of claim 12, wherein the backfill material is an elastomer.

14. The method of claim 13, wherein the elastomer is silicone rubber.

15. The method of claim 14, wherein the silicone rubber is RTV (room temperature vulcanization) silicone rubber.

16. The method of claim 12, and further comprising measuring an analytic property of a process fluid with the sensor.
